(19) United States
(12) Patent Application Publication
(10) Pub. No.: US 2026/0031587 A1
(43) Pub. Date: Jan. 29, 2026

(54) HANDHELD PULLING AND COMPRESSION DEVICE AND METHOD FOR PRODUCING A CRIMP CONNECTION

(71) Applicant: TKR Spezialwerkzeuge GmbH, Gevelsberg (DE)

(72) Inventor: Torsten KREISCHER, Wetter (DE)

(73) Assignee: TKR Spezialwerkzeuge GmbH, Gevelsberg (DE)

(21) Appl. No.: 19/270,351

(22) Filed: Jul. 15, 2025

(30) Foreign Application Priority Data
Jul. 26, 2024 (DE) 10 2024 121 358.2

(51) Int. Cl. H01R 43/042

(52) U.S. Cl. CPC H01R 43/0428

(57) ABSTRACT

A method for producing a crimp connection via a handheld pulling and compression device and to a handheld pulling and compression device for carrying out the method. For the handheld pulling and compression device, which enables reliable production of crimp connections, a control unit is provided for controlling the electric motor for adjusting the crimping punch between the crimp position and the open position, and a sensor unit connected to the control unit for monitoring the motor performance data when the crimping punch is adjusted in the direction of the crimp position. The control unit interrupts the adjustment of the crimping punch in the intermediate position when predefined first motor performance data are exceeded and/or undershot, adjusts the crimping punch further in the direction of the crimp position after reactivation and terminates the crimping process when predefined second motor performance data are reached.

The invention relates to a method for producing a crimp connection by means of a handheld pulling and compression device and to a handheld pulling and compression device for carrying out the method.

Crimp connections, i.e. connections that are made by attaching a crimp contact to a cable section with one or more strands, as well as stationary and mobile devices for producing such crimp connections are known from the prior art in a variety of configurations. In order to produce a reliable and secure connection between the crimp contact and the cable section, it is necessary to align the crimp contact in the position required for a reliable connection with respect to the cable section intended for connection to the crimp contact.

Known handheld devices for producing crimp connections generally have crimping dies shaped to match the crimp contacts, into which the crimp contacts are loosely inserted before the crimp connection is made. After the crimp contacts have been arranged at the crimping die, the cable sections are also loosely aligned manually in relation to the crimp contact and then the crimp contact is deformed by adjusting the crimping punch in relation to the crimping die so that a crimp connection is formed between the crimp contact and the cable section.

The mobile devices for producing crimp connections have the system-related problem that, due to the generally unavoidable movement of the device, there is a relative movement of the cable contact in relation to the crimp contact, which causes the cable section to move out of its intended position in relation to the cable contact, with the result that the crimp connection has defects which are reflected, for example, in a lower tensile strength of the crimp connection.

Based on this, the invention is based on the object of providing a method for producing a crimp connection by means of a handheld pulling and compression device and a handheld pulling and compression device for carrying out the method, which enable reliable production of crimp connections.

The invention solves the object by a method for producing a crimp connection having the features of claim 1 and by a handheld pulling and compression device having the features of claim 7. Advantageous further embodiments of the method according to the invention are given in dependent claims 2 to 6. Subclaims 8 to 10 describe further embodiments of the handheld pulling and compression device according to the invention.

The handheld pulling and compression device comprises
a screw drive connected to the electric motor and arranged in a housing body for transmitting tensile and compressive forces resulting from the direction of rotation of the electric motor to a coupling unit and
a crimping device with a crimping punch and a crimping die, which are adjustable relative to one another between an open position and a crimping position, the crimping punch being connected to the coupling unit and the crimping die being connected to the housing body.

In the method according to the invention for producing a crimp connection, the following method steps are carried out on the handheld pulling and compression device:
Activation of the electric motor to adjust the crimping punch towards the crimp position and monitoring of motor performance data;
Interruption of the adjustment of the crimping punch in an intermediate position if predefined first motor performance data is exceeded or not reached;
Arranging and/or aligning a crimp contact at the crimping die and/or a cable section at the crimp contact;
Reactivation of the adjustment of the crimping punch in the direction of the crimp position;
Termination of the adjustment of the crimping punch in the direction of the crimp position when predefined second motor performance data is reached and
Move the crimping punch back towards the open position.

The crimping punch and the crimping die are used to produce a crimp connection. These can be arranged, for example, at a punch holder and at a die holder at the handheld pulling and compression device by a user. A crimping punch is understood here to be a tool suitable for deforming the crimp contact and/or the cable section to be connected to the crimp contact. The crimping die describes an anvil that is designed to center the crimp contact. The cable is stripped, e.g. manually by a user using a wire stripper or mechanically, e.g. in a stripping device, in order to create a cable section suitable for connection to the crimp contact. The crimp contact is arranged at the crimping die and the exposed cable section is positioned at the crimp contact.

To produce the crimp connection, the user first activates the electric motor at the handheld pulling and compression device by actuating a switch, which causes the crimping punch to be adjusted from the open position towards the crimping position via the screw drive, i.e. the crimping punch and the crimping die are moved towards each other. When the electric motor is activated, predefined motor performance data is also monitored, which allows conclusions to be drawn about the compressive forces acting on the crimping punch and/or crimping die. The monitored motor performance data is first compared with predefined first motor performance data. As soon as the monitored motor performance data exceeds or falls below the predefined first motor performance data, whereby a defined compressive force acting on the crimping die and/or the crimping punch is detected, the adjustment of the crimping punch in the intermediate position is interrupted.

The intermediate position is selected so that, despite the compressive forces present in this position, it is possible to align the cable section in relation to the crimp contact in order to ensure reliable alignment of the cable section in relation to the crimp contact during the subsequently continued crimping process.

The amount of compressive force present between the crimping die and the crimping punch in the intermediate position determines whether, in addition to aligning the crimp contact and the cable section with each other in the area between the crimping punch and the crimping die, it is also possible to adjust the arrangement of the crimp contact at the crimping die or at least its alignment with each other and/or of the cable section at the crimping die and the crimping punch. The decisive factor here is the specification of the initial motor performance data, which determines the force between the crimping punch and the crimping die. Preferably, the first performance data is specified in such a way that a crimping die already arranged at the crimping die and the cable section previously arranged at the crimp contact can be aligned with each other.

The interruption of the adjustment of the crimping punch in the intermediate position, as provided for in the invention, makes it possible to precisely determine the alignment of the crimp contact relative to the cable section, so that any displacements that may have occurred during the adjustment of the crimping punch between the open position and the intermediate position can also be corrected. The exact alignment of the cable section in relation to the crimp contact thus ensures a high-quality crimp connection, which is completed after the alignment of the cable section in relation to the crimp contact by reactivating the adjustment of the crimping punch in the direction of the crimp position.

The interruption of the adjustment of the crimping punch in the intermediate position can be caused by the user, e.g. if the user is indicated that predefined first motor performance data has been exceeded or not reached and subsequently releases a drive switch, for example. In the event of an automated interruption, the handheld pulling and compression device interrupts the adjustment process in automated form, i.e. even when the drive switch is actuated, when the first motor performance data is reached.

To continue the crimping process, i.e. to reactivate the adjustment of the crimping punch in the direction of the crimp position, it is necessary for the user to actuate the drive switch again in the case of manual actuation. Even in the case of an automated interruption of the adjustment of the crimping punch in the direction of the crimping position in the intermediate position, the user has to actuate the drive switch again to continue the crimping process.

The crimping process is completed when the monitored motor performance data exceeds or falls below predefined second motor performance data. The predefined second motor performance data is assigned to the compressive forces acting on the crimp connection between the crimping die and the crimping punch. This means that the crimping process is terminated once a predefined pressure force has been reached. When the predefined second motor performance data is reached, this can be indicated visually and/or acoustically to the user on a display unit at the pulling and compression device, who then manually ends the crimping process. Alternatively, it is possible to automatically switch off the adjustment movement of the crimping punch in the direction of the crimp position while the actuation switch is pressed by the user, whereby the switch-off is then carried out by a control unit without the user having to intervene.

The method according to the invention thus enables an exact alignment of the cable section with respect to the crimp contact due to the interruption of the crimping process in the intermediate position according to the invention and thus the production of a high-quality crimp connection with, in particular, high tensile strength.

The selection of the motor performance data to be monitored, which allow conclusions to be drawn about the adjustment of the crimping die with respect to the crimping punch, in particular taking into account the compressive forces existing between the crimping die and the crimping punch, is in principle free. According to an advantageous embodiment of the invention, however, it is provided that the total current, single-phase currents, the battery voltage, the motor housing temperature and/or the motor speed are monitored as motor performance data and compared with corresponding predefined first and/or second performance data.

Preferably monitoring the total motor current or the single-phase currents allows conclusions to be drawn about the compressive forces existing between the crimping punch and the crimping die via the current course. During a resistance-free adjustment of the crimping punch in relation to the crimping die, the total motor current and the single-phase currents remain largely constant. Only when the crimping punch contacts the crimp contact and/or the crimping die the total motor current and the single-phase currents increase due to the resulting compressive forces acting on the crimping punch and the crimping die.

A comparison of the total motor current and/or the single-phase currents monitored during the crimping process with the first and/or second total motor current and/or the single-phase currents stored with the individual process steps thus allows simple detection of the intermediate position and the end of the crimping process. If the control unit detects that a total motor current, which is stored as first motor performance data, is exceeded, the crimping process is preferably switched off automatically, even if an actuation switch is actuated by the user. After any necessary alignment of the cable section in relation to the crimp contact the crimping process is continued by actuating the actuation switch again, whereby the total motor current or the single-phase currents continue to increase until they reach a previously defined total motor current or single-phase current stored as second motor performance data, whereupon the crimping process is automatically ended, preferably again even if the actuation switch is actuated.

The stored motor performance data can also be set taking into account the environmental parameters, such as the housing temperature. An adjustment of the first and/or second motor performance data, e.g. the total motor current or the single-phase currents, is preferably carried out automatically by the control unit, taking into account the environmental parameters such as the motor housing temperature.

According to an advantageous further development of the invention, it is preferably provided that the total motor current and/or a single-phase current are used as the first and second motor performance data, upon reaching which the adjustment in the intermediate position is interrupted. The total motor current and the single-phase currents are characterized by the fact that they allow particularly reliable and repeatable conclusions to be drawn about the forces applied by the crimping punch to the crimping die and the crimping contact arranged between them. Taking into account the total motor current and/or a single-phase current thus ensures the production of crimp connections of consistent quality with a high degree of repeat accuracy.

In an analogous manner, according to a further development of the invention, it is further provided that the total motor current and/or one or more single-phase currents are used as second performance data for determining the termination of the crimping process, after this enables a high repeat accuracy and thus the production of consistent crimp connections.

The selection or setting of the first and/or second motor performance data for determining the course of the crimping process can in principle be carried out in any way, for example, the performance data can be entered by the user via an input/output unit at the handheld pulling and compression device as a function of the crimp connections to be produced.

According to a particularly advantageous embodiment of the invention, however, it is provided that first and/or second performance data are assigned to different crimp connections and stored in a database. This embodiment of the invention makes it possible to dispense with manual input of first and second performance data when carrying out the method. The first and/or second motor performance data required for the desired crimp connections are stored in the database, which is connected to the control unit of the handheld pulling and compression device, so that the control unit can access them. Access can be either wired or wireless via a suitable communication unit, whereby in the case of a wireless connection it is possible to dispense with a database on the handheld pulling and compression device. In the case of an advantageously provided wireless connection option, the control unit can access a central database as required and retrieve the first and second performance data required for the crimp connection and store it in the device in such a way that after the crimping process has started, it is first automatically interrupted in the intermediate position and then automatically terminated after the crimping process has been continued once the second performance data has been reached.

In a particularly advantageous embodiment, the control unit is also designed to adapt the first and/or second motor performance data to the housing temperature. For example, the motor performance data can already be stored in the database with reference to the housing temperature. Alternatively, it is also possible to design the control unit in such a way that it adapts the first and second motor performance data, which are assigned to a fixed housing temperature, to the existing housing temperature by means of an algorithm.

The handheld pulling and compression device, which is provided for solving the object underlying the invention, which is suitable in particular for carrying out the method according to the invention or further method described above, has
a drive unit with a battery-operated electric motor,
a screw drive connected to the electric motor and arranged in a housing body for transmitting tensile and compressive forces resulting from a direction of rotation of the electric motor to a coupling unit and
a crimping device with a crimping punch and a crimping die.

The crimping punch and the crimping die are adjustable relative to each other between an open position and a crimp position, the crimping punch being connected to the coupling unit and the crimping die being connected to the housing body. The handheld pulling and compression device is characterized by a control unit for controlling the electric motor for adjusting the crimping punch between the crimp position and the open position and a sensor unit connected to the control unit for monitoring the motor performance data when adjusting the crimping punch in the direction of the crimp position, wherein the control unit interrupts the adjustment of the crimping punch in the intermediate position when predefined first motor performance data are exceeded and/or not reached, adjusts the crimping punch further in the direction of the crimp position after reactivation and terminates the crimping process when predefined second motor performance data are reached.

The control unit according to the invention monitors the crimping process after it has been activated by the user, after which the crimping punch is adjusted from the open position towards the crimping position. The control unit monitors the motor performance data via a sensor unit connected to the control unit and processes it. When the first motor performance data is reached, the control unit interrupts the adjustment movement of the crimping punch in the direction of the crimping position in the intermediate position, in which the user has the option to align the cable section to be connected to the crimp contact with respect to the crimp contact, so that after reactivation of the electric motor by the user and continuation of the crimping process, it is ensured that a reliable crimp connection is formed. The control unit also automatically terminates the crimping process. The termination takes place when the control unit detects by means of the sensor units that the predefined second motor performance data has been reached.

The sensor unit is preferably designed to detect the total motor current, the single-phase currents, the battery voltage, the motor housing temperature and/or the motor speed, whereby these motor performance data are all suitable for monitoring the course of the crimping process. The sensor unit is particularly preferably designed to detect the total motor current or the single-phase currents, whereby the course of the current allows particularly good conclusions to be drawn about the course of the crimping process.

A first increase in current after a largely resistance-free adjustment of the crimping punch in the direction of the crimping die indicates to the control unit that the crimping punch is interacting with the crimp contact adjusted in the crimping die and thus enables the crimping process to be interrupted in the intermediate position, in which it is possible to adjust the cable section in relation to the crimping contact.

After reactivating the crimping process, the pressure force applied to the crimping contact between the crimping die and the crimping punch can be monitored via the increasing rise in current and the crimping process can be ended when a predefined second motor current is reached, whereby the second motor current is assigned to a predefined pressure force on the crimping contact.

It is particularly preferred that the control unit is designed for wireless data transmission. Wireless data transmission enables the control unit to access motor performance data stored in a database for individual crimping processes. It is also possible for the control unit to document the crimping processes carried out via wireless data transmission.

The control unit is also preferably connected to a switching unit, which deactivates the adjustment of the crimping punch after reaching the intermediate position and must be reactivated to continue the crimping process. This enables the crimping process to be carried out automatically after the control unit automatically interrupts the switching unit after the first motor performance data has been reached, even if an actuation unit is actuated by a user. Only when the actuating unit is reactivated, for example by the user pressing a switch connected to the switching unit again, the crimping process is continued so that a crimp contact can be reliably established overall. The screw drive converts the torque of the electric motor into a compressive force and transmits it to the crimping punch via the coupling unit. The crimping punch is adjusted in the longitudinal axis direction of the crimping punch toward the crimping die. The compressive force is transferred to the crimp contact via the crimping punch and the crimp contact is plastically deformed, at least in sections, by means of the crimping punch. This creates a firm and possibly gas-tight crimp connection between the crimp contact and the cable.

An embodiment of the invention is explained below with reference to the drawings. The drawings show in:

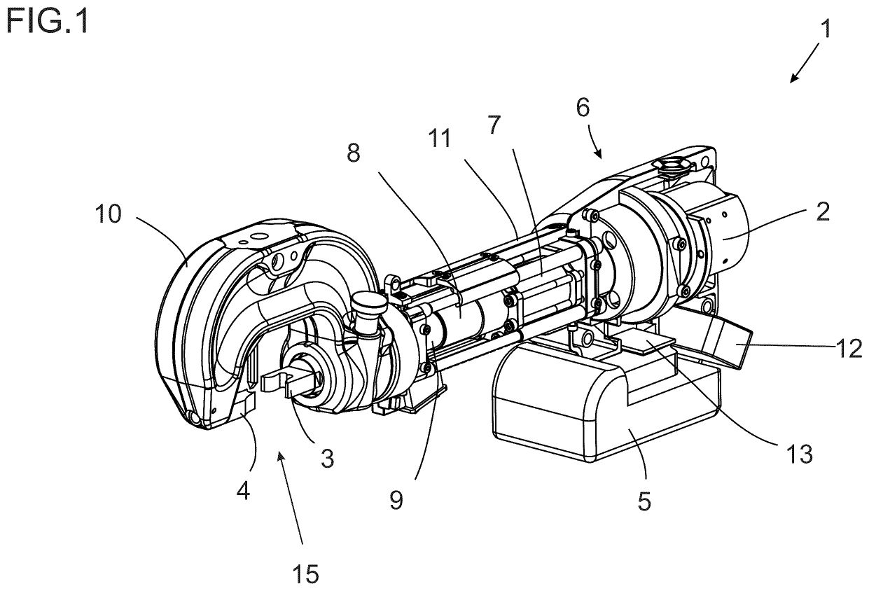

FIG. 1 a schematic representation of a handheld pulling and compression device for carrying out a method for producing a crimp connection by means of a crimping punch and crimping die arranged at the handheld pulling and compression device, and

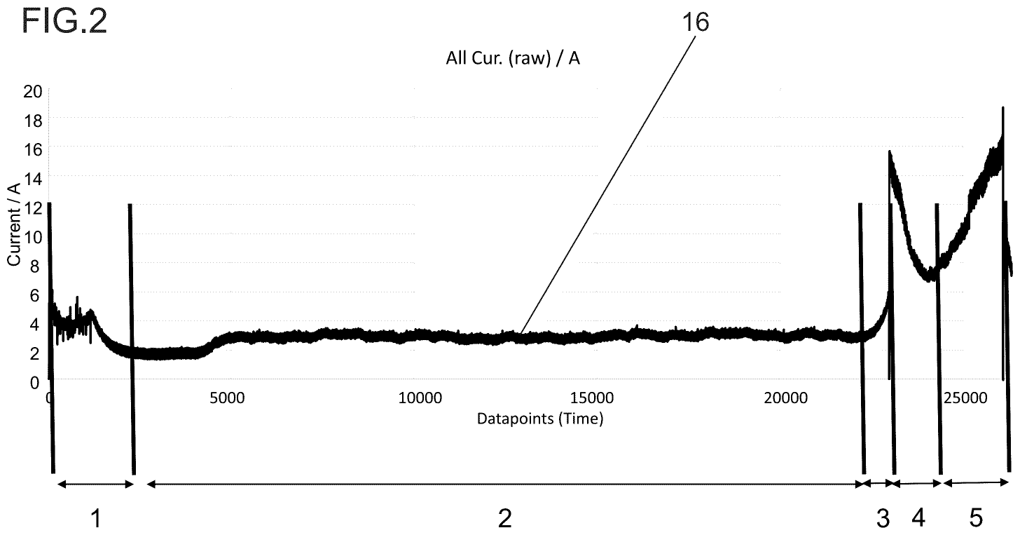

FIG. 2A diagram showing the course of a motor current during the production of a crimp connection.

FIG. 1 shows a perspective view of a handheld pulling and compression device 1 comprising a drive unit 6 operated by a rechargeable battery 5 and a screw drive 7 connected to the electric motor 2 for transmitting tensile and compressive forces resulting from the direction of rotation of the electric motor 2 to a coupling unit 8. Furthermore, the handheld pulling and compression device 1 has a punch holder 9 connected to the coupling unit 8 and a die holder 10 arranged at a housing body 11. The tensile and compressive forces can be transmitted to the punch holder 9 via the coupling unit 8.

A control unit 12 and a sensor unit, not shown here, connected to the control unit 12 for detecting the total motor current 16 are also arranged on the handheld pulling and compression device 1. The control unit 12 is connected to a communication unit 13 for wireless data exchange with a server unit, not shown here, comprising a database. The courses of the total motor current and the pressure forces assigned to them are stored in the database for individual crimp connections. The server unit also has a memory unit for documenting crimp connections.

After identifying the cable intended for connection to the crimp contact, the user determines the appropriate size of the crimp contact. In addition, the crimping punch 3 and crimping die 4 suitable for processing are selected and arranged at the punch holder 9 and die holder 10, respectively. The cable is usually stripped manually by the user using a wire stripper. The crimp contact suitable for the cable is arranged at the crimping die 4 by the user and the exposed cable section is then arranged at the crimp contact by the user.

After the crimp contact and the cable are arranged at the crimping die 4, the crimping process is started by the user. The control unit 12 controls the crimping process by executing the crimping process intended for the selected connection, whereby the crimping punch 3 is adjusted in the direction of the crimping die 4 from the open position to the crimping position. The torque of the electric motor 2 is converted into a compressive force via the threaded drive 7 and is transmitted to the crimping punch 3 via the coupling unit 8. The crimping punch 3 is adjusted in the longitudinal axis direction of the punch holder 9 in the direction of the crimping die 4. The compressive force is transmitted to the crimp contact via the crimping punch 3 and the crimp contact is plastically deformed, at least in sections, by means of the crimping punch 3.

During the adjustment of the crimping punch 3 in the direction of the crimping die 4, the control unit 12 compares the total motor current 16 determined meanwhile by means of the sensor unit with a first total motor current defined as the first motor performance data. If the monitored total motor current 16 exceeds a first total motor current previously determined as the first motor performance data, the control unit 12 interrupts the adjustment movement of the crimping punch 3 in the direction of the crimping die 4 in an intermediate position even when the actuating element 14 is pressed by the user.

In the intermediate position, the user has the option of aligning the cable section optimally in relation to the crimping die 4 after the crimp contact is reliably held in the crimping die 4 in the intermediate position.

After the cable section has been aligned with the crimping contact, the control unit 12 reactivates the crimping process via the actuating element 14, namely the displacement of the crimping punch 3 further in the direction of the crimping die 4, during which the crimping contact is plastically deformed. If the monitored total motor current 16 exceeds a second total motor current stored as second motor performance data, the control unit 12 interrupts the crimping process even if the actuating element 14 is still actuated and evaluates said crimping process as completed.

FIG. 2 shows the course of the total motor current 16 during the crimping process, namely the adjustment of the crimping punch 3 from the open position in the direction of the crimping die 4 to the crimping position.

The area marked “1” shows the course of the total motor current 16 after activation of the handheld pulling and compression device 1 and the start of the crimping process, and shows a low starting current. Subsequently (see area “2”), the crimping punch 3 is moved with the coupling unit 8 without significant counterpressure and thus with a constant total motor current 16 up to the area in which the crimping punch 3 engages with the crimp contact arranged at the crimping die 4, which is why an increase in the total motor current 16 can be seen in area “3”. This increase in the total motor current 16 is detected by the control unit 12 due to the continuous monitoring of the total motor current 16 and is interrupted in the intermediate position when a first value for the total motor current set as the first motor performance data is exceeded, which represents the drop in the total motor current 16 at the end of range “3”.

After the user reactivates the handheld pulling and compression device 1 by actuating the actuating element 14, the total motor current 16 rises steeply due to the starting current and then falls again (see area “4”), whereby the crimping punch 3 is then adjusted from the intermediate position in the direction of the crimping die 4 in the direction of the crimping position, whereby the total motor current 16 continues to rise with increasing back pressure (see area “5”). If the total motor current 16 reaches a value previously stored as second motor performance data, the control unit 12 automatically ends the crimping process (see end of range “5”).

In the embodiment example shown in FIG. 2. the total motor current 16 is designed so that the electric motor 2 builds up force to a value of 17 kN in order to crimp the crimp contact.

### LIST OF REFERENCE SYMBOLS

1 Handheld pulling and compression device
2 Electric motor
3 Crimping punch
4 Crimping die
5 Rechargeable battery
6 Drive unit
7 Screw drive
8 Coupling unit
9 Punch holder
10 Die holder
11 Housing body
12 Control unit
13 Communication unit
14 Actuating element
15 Crimping device
16 Total motor current

1. Method for producing a crimp connection by a handheld pulling and compression device with
a drive unit comprising a battery-operated electric motor,
a screw drive connected to the electric motor and arranged in a housing body for transmitting tensile and compressive forces resulting from the direction of rotation of the electric motor to a coupling unit, and
a crimping device with a crimping punch and a crimping die, which can be adjusted relative to one another between an open position and a crimping position, the crimping punch being connected to the coupling unit and the crimping die being connected to the housing body
the method comprising the steps of:
activation of the electric motor to adjust the crimping punch towards the crimp position and monitoring of motor performance data;
interruption of the adjustment of the crimping punch in an intermediate position when predefined first motor performance data is exceeded or not reached;
arranging and/or aligning a crimp contact at the crimping die and/or a cable section at the crimp contact;
reactivation of the adjustment of the crimping punch in the direction of the crimp position;
termination of the adjustment of the crimping punch in the direction of the crimp position when predefined second motor performance data are reached; and
moving back the crimping punch towards the open position.

2. Method according to claim 1, wherein the total motor current, single-phase currents, the battery voltage, the motor housing temperature and/or the motor speed are monitored as motor performance data and compared with predefined first and/or second performance data.

3. Method according to claim 1, wherein, when the total motor current and/or a single-phase current rises above a value set as the first performance data, the adjustment in the intermediate position is interrupted.

4. Method according to claim 1, wherein the adjustment of the crimping punch in the direction of the crimp position is terminated when the total motor current and/or single-phase current rises above a value adjusted as second performance data.

5. Method according to claim 1, wherein first and/or second performance data are assigned to different crimp connections and stored in a database.

6. Method according to claim 1, wherein the first and/or second performance data are adapted to the housing temperature.

7. Handheld pulling and compression device for carrying out a method for producing a crimp connection according to claim 1, the device comprising a control unit for controlling the electric motor for adjusting the crimping punch between the crimp position and the open position and a sensor unit connected to the control unit for monitoring the motor performance data during the adjustment of the crimping punch in the direction of the crimp position, wherein the control unit interrupts the adjustment of the crimping punch in the intermediate position when predefined first motor performance data are exceeded and/or not reached, adjusts the crimping punch further in the direction of the crimp position after reactivation and terminates the crimping process when predefined second motor performance data are reached.

8. Handheld pulling and compression device according to claim 7, wherein the sensor unit is designed to detect the total motor current, the single-phase currents, the battery voltage, the motor housing temperature and/or the motor speed.

9. Handheld pulling and compression device according to claim 7, wherein the control unit is designed for wireless transmission of data.

10. Handheld pulling and compression device according to claim 7, wherein the control unit is connected to a switching unit which, after reaching the intermediate position, deactivates the adjustment of the crimping punch and must be reactivated to continue the crimping process.
